(19) United States
(12) Patent Application Publication
(10) Pub. No.: US 2013/0339052 A1
(43) Pub. Date: Dec. 19, 2013

(54) System for Targeting Advertisements Based on Patient Electronic Medical Record Data

(71) Applicant: Robert A. Neff, Villanova, PA (US)

(72) Inventor: Robert A. Neff, Villanova, PA (US)

(73) Assignee: SIEMENS MEDICAL SOLUTIONS USA, INC., Malvern, PA (US)

(21) Appl. No.: 13/526,632

(22) Filed: Jun. 19, 2012

(51) Int. Cl. G06Q 30/02; G06Q 50/24; G06Q 50/22

(52) U.S. Cl. 705/3

(57) ABSTRACT

A patient specific informational material distribution system, comprises at least one repository of informational material items associated with corresponding particular medical conditions and an individual item is associated with at least one medical condition. An interface acquires patient specific medical data associating a particular medical condition with a specific patient. A data processor, coupled to the at least one repository and the interface, uses the at least one repository in identifying informational items associated with the particular medical condition of the specific patient in response to the acquired patient specific medical data. A distribution processor coupled to the data processor, distributes the identified informational items to the specific patient.

### FIELD OF THE INVENTION

This invention concerns a patient specific informational material distribution system involving identifying informational items associated with a particular medical condition of a specific patient in response to acquired patient specific medical data.

### BACKGROUND OF THE INVENTION

Advertising to patients in hospitals typically takes the form of broadcast non-patient specific advertisements to hospital inpatients. Delivering automatic advertising to patients in known systems lacks the specificity desired. Data privacy adds to the difficulty in providing advertisements of value to specific patients particularly since medical information is sensitive and subject to additional protections of HIPPA (Health Insurance Portability and Accountability Act) regulations. A system according to invention principles addresses these deficiencies and related problems and allows advertising or other information to be delivered to a particular patient based on their health conditions without requiring the delivering party to know the identity of the patient.

### SUMMARY OF THE INVENTION

A system indexes patient demographic, results, test, observation and diagnostic data acquired from patient electronic medical records and uses the indexed information to target advertisements and education materials to specific patients within a hospital facility, for example. A patient specific informational material distribution system, comprises at least one repository of informational material items associated with corresponding particular medical conditions and an individual item is associated with at least one medical condition. An interface acquires patient specific medical data associating a particular medical condition with a specific patient. A data processor, coupled to the at least one repository and the interface, uses the at least one repository in identifying informational items associated with the particular medical condition of the specific patient in response to the acquired patient specific medical data. A distribution processor coupled to the data processor, distributes the identified informational items to the specific patient.

### BRIEF DESCRIPTION OF THE DRAWING

FIG. 1 shows a patient specific informational material distribution system, according to invention principles.

FIG. 2 shows a Table of dynamically selectable weights allocated to individual context parameters associated with type of informational content being distributed, according to invention principles.

FIG. 3 shows a Table used for matching an informational content item to be distributed to a patient based on adaptive weighting for individual patient context information items, according to invention principles.

FIG. 4 shows a Table indicating an identifier of each informational content item and an associated destination IP address and time at which it was last delivered to a patient, according to invention principles.

FIG. 5 shows a flowchart of a process for distributing patient specific informational material, according to invention principles.

### DETAILED DESCRIPTION OF THE INVENTION

A system uses a patient medical record to determine ailments of a particular patient. A processor in the system builds a profile that matches the ailments of the particular patient with related informational items including educational and advertising items available in a particular hospital environment. Advertising or educational items are distributed automatically to the particular patient via one or more different communication methods within the hospital. The different communication methods include, advertising space on discharge instructions, on a television screen in the patient room, or another medium which is tailored and targeted to the particular patient (meal trays, delivered pamphlets, for example).

The system enables advertisers to provide targeted advertising to patients in a hospital. In addition to advertisers, hospitals provide targeted educational information items to patients without manual intervention. The system automatically determines what advertising or educational informational items are relevant to a particular patient and initiates delivery of the educational information or advertising. Patients in hospitals, especially when they have just been diagnosed with an ailment or condition, are most receptive to information on that condition. Non-patient specific medical advertisements have been shown to patients on cable TV in their rooms in known systems, but this is not directed advertisement and is broadcast to rooms of multiple patients. The system provides patients with individual patient specific advertisements and items that are relevant to them, and also allows advertisers to avoid providing mis-directed medical condition specific advertisements to people who do not have the specific medical condition concerned. In addition, the type of content (advertising and educational) is configurable by a hospital (or other medical organization) so the system provides a patient with specific education and advertising materials.

The system indexes patient demographic data (address, contact information, age, gender, height, weight), laboratory test results, other test information, observation and diagnostic data, acquired from patient electronic medical records (EMRs) and uses the indexed information to target advertisements and patient education within a hospital facility, for example. A patient having high blood sugar, for example, or has a diagnosis of diabetes, as determined based on an electronic medical record, is automatically provided insulin and other diabetic related advertisements. The advertisements are shown to the patient during commercial breaks in the programming on a room TV. In another embodiment, other promotional or educational materials are provided to a patient through meal delivery from a hospital cafeteria with napkins including printed patient context related advertising or information provided by the hospital (such as identifying drugs for high blood pressure, or checklists of how to reduce blood pressure), for example.

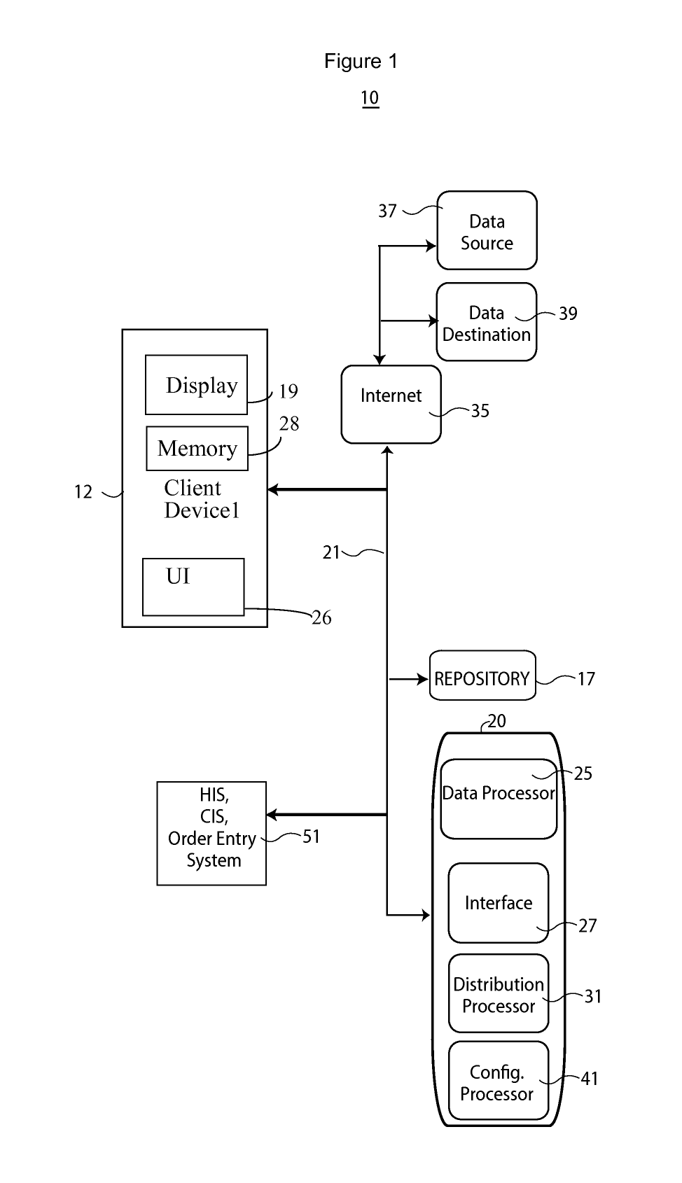

FIG. 1 shows patient specific informational material distribution system 10. System 10 includes one or more processing devices on network 21 (e.g., workstations, computers or portable devices such as notebooks, Personal Digital Assistants, phones) 12 that individually include a user interface 26 enabling user interaction with a Graphical User Interface (GUI) and display 19 supporting GUI and medical data, image and administrative information presentation, in response to predetermined user (e.g., physician, nurse administrator) specific preferences. System 10 also includes at least one repository 17, server 20 and HIS 51 (including ADT, clinical information, patient electronic medical records (EMRs), order entry and other applications) intercommunicating via network 21. Server 20 includes data processor 25, distribution processor 31, configuration processor 41 and interface 27. Server 20 communicates via network 21 and Internet 35 (or via Internet 35 directly, connection not shown to preserve drawing clarity) with data source 37 and destinations 39 (e.g. patient room TV, cafeteria, patient home). Server 20 acquires advertising and educational information and remotely communicates patient specific educational and advertising information to a patient at a remote site or to a patient home, for example.

At least one repository 17 stores informational material items associated with corresponding particular medical conditions. An individual item is associated with at least one medical condition. Interface 27 acquires patient specific medical data associating a particular medical condition with a specific patient. Data processor 25 coupled to the at least one repository 17 and interface 27, uses at least one repository 17 in identifying informational items associated with the particular medical condition of the specific patient in response to the acquired patient specific medical data. Distribution processor 31 coupled to data processor 25, distributes the identified informational items to the specific patient.

Interface 27 receives data from an EMR via standard interfaces (HL7 (HealthLevel 7) or other) that contain results, observations, diagnoses, ADT (admission, discharge, transfer) data, for example. Data processor 25 matches this information against predetermined parameter ranges, limits and medical codes (e.g. ICD9, CPT codes) to derive medical conclusions about a patient and their likelihood of being interested in one or more medical and associated advertisements or education materials available within the system. The system also uses demographics or diagnosis information to determine patient interest in particular advertisements or education. Interface 27 receives this information by room number or patient ID, (de-identified with patient name).

Data processor 25 ranks available advertisements and education materials based on a determined value to a particular patient. Once the relevant content has been determined the content is provided by distribution processor 31 or via another method (e.g. pamphlet) to the patient via one or more communication methods (configurable by the hospital). The communication methods include routing a video advertisement or education video clip to a patient room entertainment system (TV) or providing the education or advertisement in a static form on a printed napkin, or pamphlet, for example, delivered with a meal. Server 20 has inbound communication connections for receiving data from HIS system 51. The inbound connections connect to a variety of different systems concurrently. Server 20 uses database (repository 17) for storing medical information of multiple different patients (associated with a patient identifier de-identified with patient name). Repository 17 also includes advertisement and educational material content, which comprises advertisements or education materials in multiple different formats (video, print, audio, interactive games, for example). This content is tagged with identifiers indicating medical conditions to which it is relevant.

System 10 has an outbound interface in distribution processor 31 for pushing informational content to a patient via a selected communication method. For example, data processor 25 routes messages to TVs in a particular patient room via a set top box assigned to that room. System 10 also has an interface to a cafeteria to provide packaging information to deliver content with a patient meal. Output options for other different advertisement delivery methods are configurable in the system. The system includes a settings and configuration module 41 that enables settings for types of advertisements, frequency at which they are shown, audio or caption text delivery, for example and other configurable settings. Data processor 25 stores and manages content (video, paper, for example) to be shown to the patients.

When a patient is admitted to a hospital bed, patient ADT (admission, discharge, transfer) information (e.g. including admitting diagnosis, admitting department and location) is sent to Server 20. Data processor 25 ranks available advertising and educational content items for relevance to the patient. Data processor 25 via interface 27, acquires new patient specific laboratory test results and data from Healthcare Information System (HIS) 51 and uses the newly acquired patient specific medical data to re-rank patient specific advertising and educational content targeted for the specific patient and prioritizes advertising and educational material for a specific patient associated with a specific patient medical condition and needs. The ranking is automatically performed using search terms (keywords) that match both patient medical conditions and advertising and educational material text. The system is user configurable via a configuration UI and processor 41 to rank material by allocating a rank score to individual advertising and educational content items indicating relevance of the items to a particular patient medical condition and needs. The rank score is derived in one embodiment using associated weighting factors.

In response to an individual content item being acquired into the system, context parameters of the item are configured. For example, a content item related to diabetes has context parameters including one or more of the following:
Diagnosis (weight 10): Diabetes
Laboratory blood test result (weight 2): Blood sugar greater than X
Complaint (weight 5): Diabetes
   A heart disease content item has context parameters including one or more of the following:
Diagnosis (weight 10): None
Laboratory blood test result (weight 2): Cholesterol higher than X
Complaint (weight 5): Shortness of breath

In an example, a patient admitted to the hospital with a complaint of “shortness of breath”, states they have “diabetes” and has high cholesterol (higher than X) has a 7 (2+5) ranking for heart disease content and a 5 ranking for diabetes. The system automatically shows the patient content item related to heart disease primarily and only diabetes secondarily (if at all) depending on a score threshold e.g. set to a value between 5 and 7. The system in response to a predetermined frequency value configured in the system, pushes the ranked relevant content items exceeding a predetermined rank threshold to the patient on a predetermined schedule and at a predetermined frequency. The system pushes the heart disease content item using an intra-net or Internet compatible interface to a video on demand set top box system (destination 39) or other unit which delivers the heart disease content item to the patient.

System 10 processes multiple different context parameters in contextually selecting advertising and education materials for sending to a patient. The system selects a subset of these context parameters for use for a particular patient based on available data and advertising and education content items and adaptively selects weights associated with each context parameter in determining whether a particular advertisement or other item is sent to a particular patient. The system triggers sending a related advertisement or education item in response to the context parameters, or uses weighted multiple context parameters to form a trigger for sending an advertisement to a particular patient or selecting an advertisement from a set of multiple possible advertisements. An advertisement may be substituted for other content which would be served to the viewer (patient) for other purposes other than commercial gain (as is such with advertising). Other purposes may include education, entertainment, cognitive therapy, for example.

System 10 uses context parameters for matching advertisement and education material content items with a patient. The context parameters include, information from current and past stays, demographics (Name, Age, Gender, Address, height, weight), diagnosis (CPT, ICD9 codes), treatments, laboratory test results, other test results, medical assessments, nursing assessments, physician and other assessments, allergies, patient diet and meals and patient complaints. System 10 allocates a weight to individual context parameters. In one embodiment, weights are adaptively selected in response to a type of content being distributed. For example there may be multiple predetermined weights for each context parameter used and a particular weight is selected in response to the type of content that is being served. Allergies may have a weight of 100% for a Clinical type of content, however for content relating to social work centers, Allergies might have a weight of 50% whereas demographics could have a 100% weight. A date-time stamp associated with generation of context parameters is also used as a weighting factor.

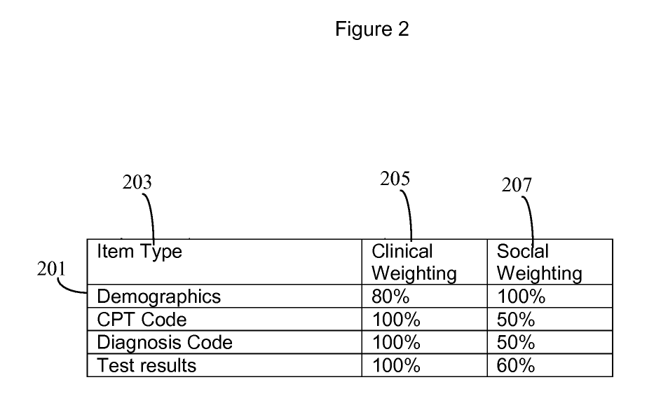

FIG. 2 shows Table 201 of dynamically selectable weights allocated to individual context parameters including demographics, CPT codes, diagnosis codes and laboratory test results, associated with type of informational content being distributed. Table 201 associates content parameters identified in column 203 with corresponding dynamically selected weightings in column 205 for a clinical category use and with corresponding weightings in column 207 for a social category use.

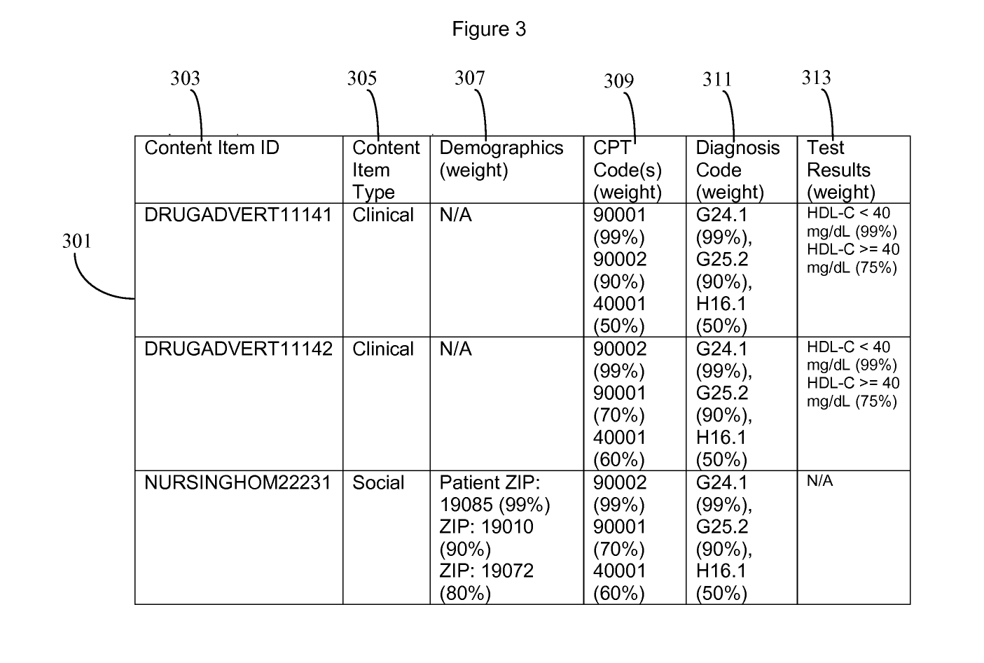

FIG. 3 shows Table 301 used for matching an informational advertisement and educational content item to be distributed to a patient based on adaptive weighting of context parameters for individual patient context information items. Table 301 associates informational advertisement and educational content items identified in column 303 with corresponding content item type (clinical or social) in column 305 and context parameters with associated weights in columns 307, 309, 311 and 313. Specifically, context parameters in columns 307, 309, 311 and 313 comprise demographics, CPT codes, diagnosis codes and laboratory test results, respectively. Interface 27 acquires patient specific medical data from a patient medical record associating a particular medical condition with a specific patient. A patient medical record includes the following data:
Doug Smith, PatID: 000121212
Patient Content Delivery IP Address: 192.128.2.5
CPT Code: 90001
Diagnosis Code: G25.2
HDL-C result: 50 mg/dL
ZIP Code: 19072

Data processor 25 identifies informational items associated with a particular medical condition of the patient in response to the acquired patient specific medical record data. Specifically, for each content item identified in column 303, a ranking is determined to match content items to the patient. For the items above for this patient, processor 25 determines rankings using,
ContentItemRank=Sum of AdaptiveWeighting*MatchWeighting
ContentItemRank=demographic*w1+CPT Code*w2+Diagnosis code*w3+test result*w4
Where w1, w2, w3, w4 are weights. Specifically,
DRUGADVERT11141 rank=0.80*0.00+1.00*0.99+1.00*0.90+1.00*0.75=2.64
DRUGADVERT11142 rank=0.80*0.00+1.00*0.70+1.00*0.90+1.00*0.75=2.35
NURSINGHOM22231 rank=1.00*0.80+0.50*0.70+0.50*0.90+0.60*0.00=1.60

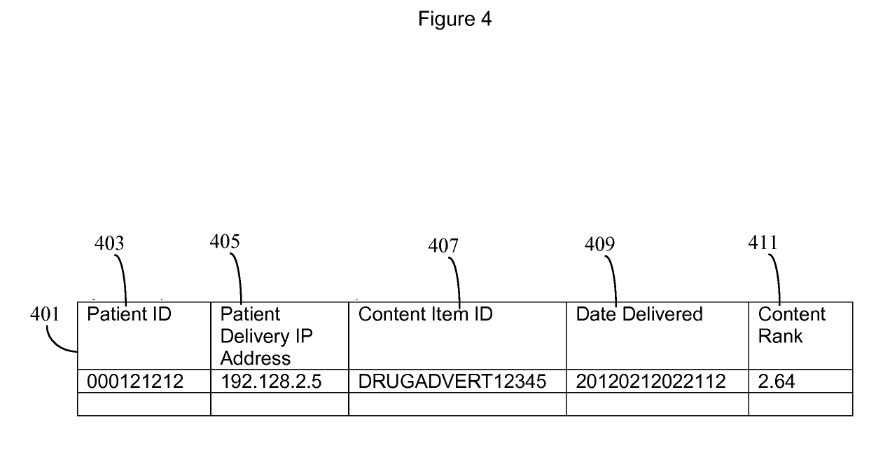

FIG. 4 shows Table 401 indicating an identifier of each informational content item identified in column 407 with calculated rank in column 411 and an associated destination IP address in column 405 and date, time in column 409 at which it was last delivered to a patient identified in column 403. Processor 25 matches individual acquired patient specific medical record data items to a type of item such as social or clinical type in column 305 (FIG. 3) and associates a set of weights to context parameters of the individual item based on the matched type. For example, if the content item to be distributed is of a Social category, the appropriate weight set (e.g. of column 207 FIG. 2) is applied to context parameters of the patient.

In an operation example, a social category content item is to be presented to a patient. System 10 (FIG. 1) determines what type of category of content to present in different areas of a display image. HIS 51 provides patient data to advertising distribution server 20 and data processor 25 determines a rank for individual content items by summing weighted context parameters comprising items of patient data, using a set of weights for a category concerned (e.g. clinical or social), as previously described. For content items having a rank score exceeding a threshold, the system distributes a first content item having a highest rank score to the patient a predetermined number of times and subsequently (or concurrently) distributes a second content item with a next highest rank score to the patient a predetermined number of times. This is repeated till content items with rank score exceeding the threshold are presented to the patient. In one embodiment a lookup table includes individual columns associating, data identifying an informational item e.g. asthma, data identifying a diagnosis and associated CPT, ICD9 codes, a complaint, a laboratory test result, a patient destination IP address and a relevance ranking score

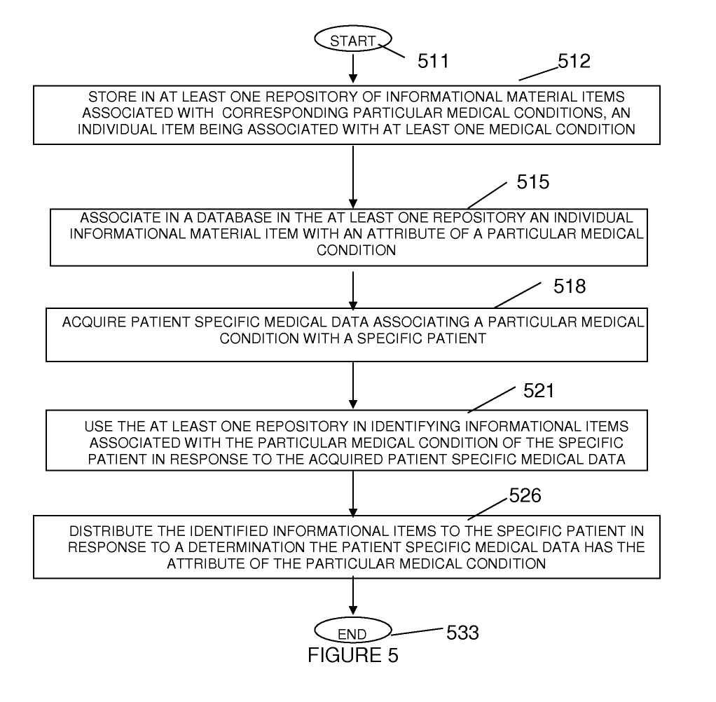

FIG. 5 shows a flowchart of a process for distributing patient specific informational material performed by system 10 (FIG. 1). Data processor 25 in step 512, following the start at step 511, stores in at least one repository 17 (e.g. a database), informational material items associated with corresponding particular medical conditions and an individual item is associated with at least one medical condition. In step 515, a database in at least one repository 17 associates an individual informational material item with an attribute of a particular medical condition. The attributes comprises a diagnosis, laboratory test result and a complaint. The database associates an individual informational material item with multiple attributes of a particular medical condition and associated individual attribute weighting values, of a particular medical condition. The database also associates an individual informational material item with an attribute and associated attribute score value of a particular medical condition.

The informational material items comprise at least one of, (a) advertisements and (b) educational materials. An individual attribute is associated with multiple of different predetermined individual attribute weighting values and a particular weight of the multiple of different predetermined individual attribute weighting values is selected in response to a type of the diagnosis. Further, a particular weight of the multiple of different predetermined individual attribute weighting values is selected in response to a type of an individual informational material item. The type of an individual informational material item comprises at least one of, (a) a clinical type and (b) a social type.

In step 518, interface 27 acquires patient specific medical data associating a particular medical condition with a specific patient. Data processor 25 in step 521, uses at least one repository 17 in identifying informational items associated with the particular medical condition of the specific patient in response to the acquired patient specific medical data. In step 526 distribution processor 31 automatically distributes the identified informational items to the specific patient, in response to a determination the patient specific medical data has the attribute of the particular medical condition. Processor 31 distributes the individual informational material item to the specific patient in response to a determination the patient specific medical data has the attributes of the particular medical condition. The multiple attributes comprise at least two of, (a) Information from current and past inpatient stays, (b) patient Age, Gender, height or weight, (c) Diagnosis codes, (d) Treatments, (e) Laboratory test results, (f) Medical Assessments, (g) Allergies, (h) diet and (h) medical complaint.

Processor 31 in one embodiment, distributes the individual informational material item to the specific patient in response to a determination the patient specific medical data has the attribute of the particular medical condition and the score values exceeds a predetermined threshold. Alternatively, processor 31 in one embodiment, distributes the individual informational material item to the specific patient in response to a determination the patient specific medical data has the multiple different attributes of the particular medical condition and a sum of the weighting values or in response to the sum of the weighting values or a value derived using the sum of the weighting values, exceeds a predetermined threshold. The process of FIG. 5 terminates at step 531.

A processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and is conditioned using executable instructions to perform special purpose functions not performed by a general purpose computer. A processor may be coupled (electrically and/or as comprising executable components) with any other processor enabling interaction and/or communication there-between. Computer program instructions may be loaded onto a computer, including without limitation a general purpose computer or special purpose computer, or other programmable processing apparatus to produce a machine, such that the computer program instructions which execute on the computer or other programmable processing apparatus create means for implementing the functions specified in the block(s) of the flowchart(s). A user interface processor or generator is a known element comprising electronic circuitry or software or a combination of both for generating display images or portions thereof. A user interface comprises one or more display images enabling user interaction with a processor or other device.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A graphical user interface (GUI), as used herein, comprises one or more display images, generated by a display processor and enabling user interaction with a processor or other device and associated data acquisition and processing functions.

The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of an executable procedure or executable application, manipulates the UI display images in response to signals received from the input devices. In this way, the user interacts with the display image using the input devices, enabling user interaction with the processor or other device. The functions and process steps herein may be performed automatically or wholly or partially in response to user command An activity (including a step) performed automatically is performed in response to executable instruction or device operation without user direct initiation of the activity.

The system and processes of the FIGS. 1-5 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. A system uses patient data acquired from a patient medical record to determine ailments of a particular patient and build a patient specific profile associating patient specific ailments with related informational items and automatically distributes the items to the patient. Further, the processes and applications may, in alternative embodiments, be located on one or more (e.g., distributed) processing devices on a network linking the units of the system of FIG. 1. Any of the functions and steps provided in FIGS. 1-5 may be implemented in hardware, software or a combination of both. No claim element herein is to be construed under the provisions of 35 U.S.C. 112, sixth paragraph, unless the element is expressly recited using the phrase “means for”.

What is claimed is:

1. A patient specific informational material distribution system, comprising:
at least one repository of informational material items associated with corresponding particular medical conditions, an individual item being associated with at least one medical condition;
an interface for acquiring patient specific medical data associating a particular medical condition with a specific patient;
a data processor, coupled to said at least one repository and said interface, for using said at least one repository in identifying informational items associated with said particular medical condition of said specific patient in response to the acquired patient specific medical data; and
a distribution processor coupled to said data processor, for distributing the identified informational items to said specific patient.

2. A system according to claim 1, wherein
said at least one repository associates an individual informational material item with an attribute of a particular medical condition and
said distribution processor distributes said individual informational material item to said specific patient in response to a determination said patient specific medical data has said attribute of said particular medical condition.

3. A system according to claim 2, wherein
said attribute comprises a diagnosis.

4. A system according to claim 2, wherein
said attribute comprises at least one of, (a) laboratory test result and (b) a complaint.

5. A system according to claim 1, wherein
said at least one repository associates an individual informational material item with a plurality of attributes of a particular medical condition and
said distribution processor distributes said individual informational material item to said specific patient in response to a determination said patient specific medical data has said attributes of said particular medical condition, said plurality of attributes comprising at least three of, (a) Information from current and past inpatient stays, (b) patient Age, Gender, height or weight, (c) Diagnosis codes, (d) Treatments, (e) Laboratory test results, (f) Medical Assessments, (g) Allergies, (h) diet and (h) medical complaint.

6. A system according to claim 1, wherein
said at least one repository associates an individual informational material item with an attribute and associated attribute score value of a particular medical condition and
said distribution processor distributes said individual informational material item to said specific patient in response to a determination said patient specific medical data has said attribute of said particular medical condition and said score values exceeds a predetermined threshold.

7. A system according to claim 1, wherein
said at least one repository associates an individual informational material item with a plurality of different attributes and associated individual attribute weighting values, of a particular medical condition and
said distribution processor distributes said individual informational material item to said specific patient in response to a determination said patient specific medical data has said plurality of different attributes of said particular medical condition and a sum of said weighting values.

8. A system according to claim 7, wherein
said distribution processor distributes said individual informational material item to said specific patient in response to said sum of said weighting values or a value derived using said sum of said weighting values, exceeding a predetermined threshold.

9. A system according to claim 7, wherein
an individual attribute is associated with a plurality of different predetermined individual attribute weighting values and a particular weight of said plurality of different predetermined individual attribute weighting values is selected in response to a type of an individual informational material item

10. A system according to claim 9, wherein
said type of an individual informational material item comprises at least one of, (a) a clinical type and (b) a social type.

11. A system according to claim 7, wherein
an individual attribute comprises a diagnosis and
said individual attribute is associated with a plurality of different predetermined individual attribute weighting values and a particular weight of said plurality of different predetermined individual attribute weighting values is selected in response to a type of said diagnosis.

12. A system according to claim 1, wherein
said informational material items comprise at least one of, (a) advertisements and (b) educational materials.

13. A patient specific informational material distribution method, comprising the activities of:
storing in at least one repository, informational material items associated with corresponding particular medical conditions, an individual item being associated with at least one medical condition;
acquiring patient specific medical data associating a particular medical condition with a specific patient;
using said at least one repository in identifying informational items associated with said particular medical condition of said specific patient in response to the acquired patient specific medical data; and
distributing the identified informational items to said specific patient.

14. A method according to claim 13, including the steps of
associating in a database in said at least one repository an individual informational material item with an attribute of a particular medical condition and
distributing said individual informational material item to said specific patient in response to a determination said patient specific medical data has said attribute of said particular medical condition.

15. A method according to claim 14, wherein
said attribute comprises a diagnosis.

16. A method according to claim 14, wherein
said attribute comprises at least one of, (a) laboratory test result and (b) a complaint.

17. A method according to claim 13, including the steps of
associating in a database in said at least one repository an individual informational material item with a plurality of attributes of a particular medical condition and
distributing said individual informational material item to said specific patient in response to a determination said patient specific medical data has said attributes of said particular medical condition, said plurality of attributes comprising at least three of, (a) Information from current and past inpatient stays, (b) patient Age, Gender, height or weight, (c) Diagnosis codes, (d) Treatments, (e) Laboratory test results, (f) Medical Assessments, (g) Allergies, (h) diet and (h) medical complaint.

18. A method according to claim 13, including the steps of
associating in a database in said at least one repository an individual informational material item with an attribute and associated attribute score value of a particular medical condition and
distributing said individual informational material item to said specific patient in response to a determination said patient specific medical data has said attribute of said particular medical condition and said score values exceeds a predetermined threshold.

19. A method according to claim 13, including the steps of
associating in a database in said at least one repository an individual informational material item with a plurality of different attributes and associated individual attribute weighting values, of a particular medical condition and
distributing said individual informational material item to said specific patient in response to a determination said patient specific medical data has said plurality of different attributes of said particular medical condition and a sum of said weighting values.

20. A method according to claim 19, including the step of
distributing said individual informational material item to said specific patient in response to said sum of said weighting values or a value derived using said sum of said weighting values, exceeding a predetermined threshold.

21. A method according to claim 19, wherein
an individual attribute is associated with a plurality of different predetermined individual attribute weighting values and a particular weight of said plurality of different predetermined individual attribute weighting values is selected in response to a type of an individual informational material item.

22. A method according to claim 21 wherein
said type of an individual informational material item comprises at least one of, (a) a clinical type and (b) a social type.

23. A method according to claim 19, wherein
an individual attribute comprises a diagnosis and
said individual attribute is associated with a plurality of different predetermined individual attribute weighting values and a particular weight of said plurality of different predetermined individual attribute weighting values is selected in response to a type of said diagnosis.

24. A method according to claim 13, wherein
said informational material items comprise at least one of, (a) advertisements and (b) educational materials.
